(19) United States
(12) Patent Application Publication
(10) Pub. No.: US 2014/0155527 A1
(43) Pub. Date: Jun. 5, 2014

(54) FLAME RETARDANT POLYOLEFIN COMPOSITION FOR SHIPPING PALLETS

(71) Applicant: ICL-IP America Inc., Ardsley, NY (US)

(72) Inventors: Sergei V. Levchik, Croton-on-Hudson, NY (US); Gerald R. Alessio, Emerson, NJ (US); Yankai Yang, Ardsley, NY (US)

(73) Assignee: ICL-IP America Inc., Ardsley, NY (US)

(21) Appl. No.: 13/916,031

(22) Filed: Jun. 12, 2013

Related U.S. Application Data
(60) Provisional application No. 61/661,079, filed on Jun. 18, 2012.

(51) Int. Cl. C08K 5/56; C08K 3/22

(52) U.S. Cl. CPC C08K 5/56; C08K 3/22
USPC 524/123

(57) ABSTRACT

There is provided herein a flame retarded polyolefin composition comprising a thermoplastic polyolefin polymer, an inorganic flame retardant and a synergist comprising a metal phosphonate represented by the formula:

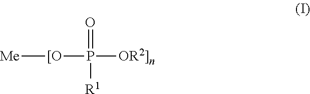

There is also provided a method for making a flame retarded polyolefin composition comprising contacting at least one thermoplastic polyolefin polymer with at least one inorganic flame retardant and at least one metal phosphonate and heating the mixture of thermoplastic polyolefin polymer, at least one inorganic flame retardant and at least one metal phosphonate above the melting temperature of the thermoplastic polyolefin polymer.

### FIELD OF THE INVENTION

The present invention pertains to a flame retarded polyolefin composition for the manufacture of shipping pallets.

### BACKGROUND ART

In the past, shipping pallets were made largely of wood. More recently, numerous materials have at least partially superseded wood-based pallets. For example, pallets of injection molded polymers are being used increasingly. Such polymer pallets have numerous advantages. For example, polymer pallets are capable of being molded in complex shapes which facilitate the shipping of numerous types of articles. Polymer pallets are also easy to clean, which encourages their reuse.

Wood pallets are inherently combustible, and are rather easily ignited. While polymer articles are in general somewhat more difficult to ignite, once ignited they also constitute combustible products, and can release even more heat than wood pallets. In the shipping industry, empty pallets are often stacked together for reuse or for return to the shipper (“idle storage”). When wood pallets are so stacked and ignited, the fire is generally concentrated in an upward direction. However, when polymer pallets burn, in addition to having greater fuel load (combustibility), the flame can also spread downward by dripping. Thus, the combustion of polymer pallets involves more heat compared to wood pallets. Thus, it is desirable to minimize the combustibility and heat release, and in turn, lower the flame spread of polymer based pallets. It is further desirable to provide pallets which mimic the behavior of wood pallets during combustion, and which are preferably improved with respect to combustion properties.

A standard test for pallet flammability has been established by Underwriters Laboratories, as UL 2335 “Fire Tests of Storage Pallets”. In one version of this test, the “Idle Pallet Test,” six stacks of pallets are assembled in a 2×3 array with a 6″ longitudinal flue space longitudinally between arrays in a room with a 30-foot high flat ceiling having 165° F. (74° C.) standard response sprinklers having a design density of 0.60 gpm/ft². An instrumented steel beam is placed near the ceiling, and the pallets are ignited by a hydrocarbon soaked cellulosic bundle positioned in the flue space. The parameters assessed include flame spread, maximum steel beam temperature, and number of sprinklers activated. As can be seen, this test is a rather stringent one.

One solution which has been proposed is to produce pallets of polymers which are less flammable than pallets of commodity resins such as polyolefins. However, such specialty polymers, e.g. polyphenylene oxide polymers, are considerably more expensive than the polyolefin polymers conventionally used to manufacture pallets. Such specialty polymers are also, in general, much more difficult to mold than polyolefins. It has also been proposed to add flame retardant compositions which include halogenated organic flame retardants and antimony trioxide. However, such flame retardants are becoming increasingly regulated in some geographical areas. Therefore pallets manufacturers and users are trying to avoid use of halogenated flame retardants.

Few solutions have been proposed for halogen-free polyolefin compositions for shipping pallets. One solution suggests use of mineral flame retardants for example aluminum hydroxide or magnesium hydroxide. These flame retardants are less efficient compared to halogenated flame retardants and therefore require higher loadings, typically higher than 40% wt. % in the polyolefin composition.

Another solution suggests use of ammonium polyphosphate alone or in combination with synergist pentaerythritol. Ammonium polyphosphate (APP) based compositions usually require only about 20 wt. % loading, however they suffer from another shortcome of being water sensitive, and therefore facing the risk of being washed out of the pallet. Furthermore, ammonium polyphosphate decomposes at relatively low temperature, which makes APP based compositions difficult to process. Even furthermore, APP based compositions are difficult to recycle.

Although numerous flame retardants and combinations thereof are known for use in plastic articles generally, the stringent tests required of pallets render flame retardancy results unpredictable. Numerous flame retardants and combinations have been tested, and while many of these have been found suitable for polyolefin articles other than pallets, their use in pallets has not proven acceptable.

It would be desirable to provide a polyolefin composition suitable for use in molding pallets which is injection moldable, exhibits good flame retardancy in standard tests, and which is commercially cost effective.

### SUMMARY OF THE INVENTION

According to the present invention there is provided a flame retarded polyolefin composition comprising:

(a) a thermoplastic polyolefin polymer;
(b) an inorganic flame retardant;
(c) a synergist comprising a metal phosphonate of the general formula (I)

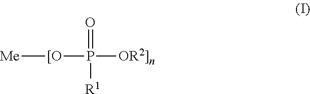

where Me is a metal, n is equal to the valency of the metal and is in the range of from 1 to 4, R¹ is a linear or branched alkyl of up to about 12 carbon atoms, R² is a linear or branched alkyl of up to about 12 carbon atoms, or a substituted aryl or an unsubstituted aryl of the general formula (II):

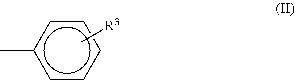

where R³ is hydrogen, or a branched or linear alkyl of up to about 4 carbon atoms, or NH₂ or CN or NO₂, wherein the inorganic flame retardant is present in an amount of from about 5 weight percent to about 40 weight percent.

Further the flame retarded polyolefin composition can optionally comprise fillers, impact modifiers, heat stabilizers, antioxidants, processing aids, and other additives enhancing physical properties of the resin.

Furthermore, the present invention is directed to a molded flame retarded shipping pallet comprising the flame retarded polyolefin composition described herein.

Further still, the present invention is also directed to a molded flame retarded shipping pallet comprising a thermoplastic polyolefin polymer, an inorganic flame retardant, aluminum methyl methylphosphonate and optionally fillers, antioxidants, processing aids, and colorants.

Still further, the present invention is directed to a method of making a flame retarded polyolefin composition comprising:

contacting at least one thermoplastic polyolefin polymer with at least one inorganic flame retardant and at least one metal phosphonate; and,

heating the mixture of thermoplastic polyolefin polymer, at least one inorganic flame retardant and at least one metal phosphonate to above the melting temperature of the thermoplastic polyolefin polymer, wherein the inorganic flame retardant is present in an amount of from about 5 weight percent to about 40 weight percent.

### DETAILED DESCRIPTION OF THE PREFERRED EMBODIMENTS

In the practice of the present invention, a composition is prepared which is broadly composed of a mixture of the herein-described compounds. A polyolefin resin of essentially any grade can be selected as the thermoplastic polyolefin polymer according to the desired performance requirements such as formability and mechanical properties, including stiffness, heat resistance, and the like, of the resulting polyolefin polymer composition.

The thermoplastic polyolefin polymer (a) is preferably at least one of a polyethylene homopolymer, polyethylene copolymer, polypropylene homopolymer, and polypropylene copolymer. In one embodiment, the thermoplastic polyolefin polymer (a) is a high-density polyethylene, a low-density polyethylene or a linear low density polyethylene. Amorphous, crystalline and elastomeric forms of polypropylene can be applied in this invention. Examples of the copolymers which can be used as the thermoplastic polyolefin polymer (a) are at least one of, such as but not limited to, ethylene-vinyl acetate (EVA); ethylene-propylene rubber (EPR); ethylene-propylene-diene-monomer rubber (EPDM); and copolymers of ethylene and propylene with butene-1, pentene-1,3-methylbutene-1,4-methylpentene-1, octene-1 and mixtures thereof.

In one embodiment, ethylene polymers can be used as the thermoplastic polyolefin polymer and can be selected from the non-limiting examples of low-density polyethylene (LDPE), linear low-density polyethylene (LLDPE), linear very low-density polyethylene (VLDPE), high-density polyethylene (HDPE), ethylene-methyl methacrylate (EMMA) copolymer, ethylene methyl acrylate (EMA) copolymer, ethylene ethyl acrylate (EEA) copolymer, ethylene butyl acrylate (EBA) copolymer, ethylene vinyl acetate (EVA) copolymer, ethylene glycidyl methacrylate copolymer, ethylene-butene-1 copolymer, ethylene-butene-hexene terpolymer, ethylene propylene diene terpolymer (EPDM), ethylene-octene copolymer (EOR), ethylene copolymerized polypropylene (random PP or block PP), ethylene propylene (EPR) copolymer, poly-4-methyl-pentene-1, maleic anhydride grafted low-density polyethylene, hydrogenated styrene-butadiene (H-SBR) copolymer, maleic anhydride grafted linear low-density polyethylene, maleic anhydride grafted linear very low-density polyethylene, copolymers of ethylene and α-olefin with a carbon number of 4 to 20, ethylene-styrene copolymer, maleic anhydride grafted ethylene-styrene copolymer, maleic anhydride grafted ethylene-methyl acrylate copolymer, maleic anhydride grafted ethylene-vinyl acetate copolymer, ethylene-maleic anhydride copolymer, ethylene-ethyl acrylate-maleic anhydride terpolymer, and ethylene-propylene-butene-1 terpolymer including butene-1. These compounds may be used individually. Alternatively, two or more types of them may be blended.

The thermoplastic polyolefin polymer is preferably applied in pellet form having a melting point in the range of from about 150 to about 250° Celsius (C.), most preferably from about 175° C. to about 230° C. The thermoplastic polyolefin polymer preferably has a specific gravity in the range of from about 0.85 to about 1.2 and most preferably about 0.90-1.0. The thermoplastic polyolefin resin of choice preferably has a melt flow rate in the range of from about 0.2 to about 30 g/10 min., and more preferably, from about 1 to about 12 g/10 min.

The thermoplastic polyolefin polymers may also be reinforced or filled. Suitable fillers for the thermoplastic polyolefin polymer include typical reinforcing and non-reinforcing fillers such as precipitated and fumed silicas, ground quartz, diatomaceous earth, ground limestone, ground felspar, mica, expanded mica, precipitated calcium carbonate, etc. The term “reinforcing” with respect to fillers generally refers to fillers of small size and high surface area, for example mean particle sizes of about 0.1 μm or less, and specific surface areas (BET) of 50 m²/g or higher while non-reinforcing fillers, which are preferred, have larger particles sizes, e.g. 1 to 100 μm, preferably 1 to 20 μm. Suitable fibrous fillers are typically short or long glass fibers. Other fibrous reinforcement such as aramid fiber, carbon fiber, boron nitride fiber, etc., may also be used, however such materials are generally more expensive than glass fibers.

In another embodiment of this invention the flame retarded polyolefin composition herein can further optionally contain nanofiller, for example organically treated clay or carbon nanotubes.

The polyolefin polymer (a) is preferably present in the flame retarded polyolefin composition in an amount of from 60 to 95 wt. %, more preferably from 70 to 90 wt. % based on the total weight of the composition.

Suitable inorganic flame retardants (b) are known in the art. Specific, preferred inorganic flame retardant include magnesium hydroxide (Mg(OH)₂), aluminum hydroxide (Al(OH)₃), boehmite, hydrotalcite, basic magnesium carbonate, calcium aluminate hydrate, talc and clay.

The principle flame retardant for use in the flame retarded polyolefin composition for shipping pallets is magnesium hydroxide (MDH), which is widely available from synthetic sources such as precipitation from brines. It is also available from natural sources, such as crushed minerals, for example, brucite. Precipitated magnesium hydroxide is widely available, for example from ICL-IP, and from other sources. Aluminum hydroxide also known as alumina trihydrate (“ATH”) is also available from numerous sources, and may be used in the same particle size ranges as for magnesium hydroxide.

From the viewpoints of mechanical properties, ease of dispersion and flame retardancy, the above inorganic flame retardants are more preferable when the average particle diameter of the powder is 10 μm or less and when the ratio of coarse particles with a particle diameter of 25 μm or more is 10% or less to the total filler. It is also possible to increase the water resistance by treating the surfaces of these particles, using a fatty acid, fatty acid metal salt, silane coupling agent, titanate coupling agent, acrylate resin, phenol resin, cationic or nonionic water-soluble resin, or the like, according to the usual manner. The surface treatment is also beneficial for improving resin from during extrusion and molding.

Inorganic flame retardant (b) is present in an amount of from about 5 weight percent to about 40 weight percent based on the total weight of the flame retarded polyolefin composition. In one embodiment, the inorganic flame retardant (b) preferably makes up to 10-25% by weight of the composition of the present invention and more preferably from about 5 to less than 20% by weight of the composition based on the polymer components, flame retardant filler and metal phosphonate.

The metal phosphonate (c) used herein can be a salt of alkyl alkylphosphonic acid or a salt of aryl alkylphosphonic acid. In one embodiment the salt of alkyl alkylphosphonic acid or salt of aryl alkylphosphonic acid can be such that the alkyl group and/or aryl group contains up to about 12 carbon atoms. In a further embodiment the metal phosphonate (c) is represented by general formula (I):

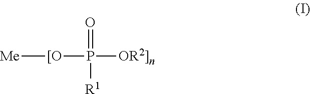

where Me is a metal, n is equal to the valency of the metal which is in the range of from 1 to 4, specifically 2 or 3, R¹ is a linear or branched alkyl of up to about 12 carbon atoms, specifically from 1 to about 4 carbon atoms, R² is a linear or branched alkyl of up to about 12 carbon atoms, specifically from 1 to about 4 carbon atoms or a substituted aryl or an unsubstituted aryl of general formula (II):

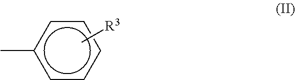

where R³ is hydrogen, or a branched or linear alkyl of up to about 4 carbon atoms, or NH₂ or CN or NO₂.

In one specific embodiment, R¹ and/or R² are each independently methyl or ethyl radicals.

Metals, i.e., Me of the above formula (I), include alkaline earth or transition metals such as the non-limiting group consisting of Ca, Mg, Zn, Al, Fe, Ni, Cr, Ti. The most specific metal is Al.

In one embodiment the metal phosphonate (c) of the formula (I) is an aluminum salt of methyl methylphosphonic acid (AMMP), where Me is aluminum, R¹ and R² are both methyl and n=3. AMMP contains a high level (i.e., 26 weight percent) of active phosphorus. AMMP can be synthesized either by reacting methyl methylphosphonate with an aqueous solution of sodium hydroxide followed by precipitation with aluminum chloride, or by direct reaction of aluminum hydroxide with methyl methylphosphonate at about 180° C. in high shear mixer.

Specifically, the metal phosphonate (c) is a powder with an average particle size of less than about 25 microns, specifically less than about 10 microns, and even more specifically less than about 5 microns. The most specific metal phosphonate (c) average particle size according to the present embodiments comprises an average size in the range of from about 0.1 microns to about 3 microns. It will be understood that any of the aforementioned average particle size ranges can have a lower end point of from about 0.1 microns.

Preferably, the synergist (c) is present in the flame retarded polyolefin composition in an amount from about 0.5 to about 25 wt. %, more preferably in the range from about 0.5 to about 10 wt. %, even more preferably from about 0.5 to about 5 wt. % and most preferably from about 0.5 to less than 3 wt. % based on the total weight of the flame retarded polyolefin polymer composition.

Additional flame retardant ingredients are also possible. These include both organic and inorganic retardants. Organic flame retardants include numerous conventional nitrogenous organic compounds such as but not limited to ureas, derivatized ureas, urea and/or melamine/formaldehyde condensates, cyanurates and isocyanurates, melamine derivatives, carbamates, etc. Inorganic flame retardants include various metal carbonates, metal bicarbonates, an metal oxides, metal phosphates and ammonium phosphates, etc. Hydrated inorganic compounds which serve as water generators are also useful.

Highly charring agents such as pentaerythritol, sugars and starches may also be useful, as well as expandable fillers such as expandable mica or graphite. Expanded products such as expanded mica and expanded graphite may also be useful in minor amounts, i.e. amounts which can be incorporated without overly lowering the density and affecting the physical characteristics of the polymer. Glass or ceramic microspheres may also be useful.

In one embodiment herein, the flame retarded polyolefin composition can further optionally incorporate an auxiliary solid phosphate ester. The role of the phosphate ester is to improve the resin flow and provide additional flame retardancy. The solid phosphate ester is preferably an aromatic phosphate or bisphosphate.

In yet another embodiment of this invention the flame retarded polyolefin composition can further optionally contain zinc borate.

The flame retarded polyolefin composition may further contain one or more additional additives which are known in the art, such as, for example, ultraviolet and light stabilizers, UV screeners, UV absorbers, heat stabilizers, antioxidants, dispersing agents, lubricants and combinations thereof.

In the method of the invention, the thermoplastic polyolefin polymer, the inorganic flame retardant, the metal phosphonate synergist and any other components, are blended in the desired quantities and heated to a temperature above the melting point of the thermoplastic polyolefin polymer. The heating and blending can be done in either order, however, in the preferred embodiment, these processes are conducted simultaneously. The mixing may be conducted in any suitable equipment including a batch mixer, Banbury mixer, single or twin screw extruder, ribbon blender, injection molding machine, two-roll mill or the like.

The flame retardant ingredients (b) and (c) may be incorporated into the thermoplastic polyolefin polymer by conventional techniques, i.e. in mixers or blenders, but preferably in an extruder, i.e. a single screw, or preferably a twin screw extruder. It has been found that preparation of a master batch of the same or different thermoplastic polyolefin polymer containing approximately 2 to 5 times, preferably 2.5 to 4 times the combined weight of components (b) and (c) of the flame retarded polyolefin composition is particularly useful. For example, a master batch containing about 45 weight percent magnesium hydroxide and about 10 weight percent aluminum methyl methylphosphonate, balance polypropylene polymer, may be useful in forming pallets. A master batch may contain greater than 65 weight percent of flame retardant ingredients, i.e., components (b) and (c) as well as any other optional flame retardant components. The master batch is then blended or “diluted” with additional thermoplastic polymer polyolefin (a) in an extruder prior to injection molding. By “extruder” is meant a screw-type device used to blend thermoplastics to form extrudates or to supply molten thermoplastic to an injection molding machine. The term should not be viewed as limiting, and other mixers may in principle be used.

In one embodiment herein, the flame retarded polyolefin composition of this invention will show a significant decrease in the heat release rate as measured in the cone calorimeter test. It is believed that reduced heat release polyolefin composition has higher probability of passing UL 2335 “Fire Tests of Storage Pallets” compared to flame retardant compositions without the synergist (c) used herein.

In another embodiment of this invention the molded flame retarded polyolefin composition is shredded into small chips and molded again simulating pallets recycling process. The molded flame retarded polyolefin composition still maintains low heat release rate as measured in the cone calorimeter test and good physical properties.

In yet another embodiment of this invention there is provided a shipping pallet manufactured out of the flame retarded polyolefin composition comprising thermoplastic polyolefin polymer (a), inorganic flame retardant (b) and metal phosphonate (c).

The following examples are used to illustrate the present invention.

### EXAMPLES

In order to prepare samples of the flame-retarded polyolefin composition that illustrate the invention, the following procedures have been used.

### 1. Materials.

A list of the materials used in these examples is as follows:

(a)—Polypropylene Impact Copolymer, ASI Polypropylene 1404-01, ex. A. Schulman
(b)—Magnesium hydroxide, FR-20-120D-S7, MDH ex. ICL-IP
(c)—Aluminum methyl methylphosphonate, AMMP, ex. ICL-IP

### 2. Compounding

The polymers pellets, MDH and AMMP were weighted on semi analytical scales with consequent manual mixing in plastic bags. The mixtures were introduced into the main feeding port of the extruder.

Compounding was performed using a C. W. Brabender conical twin screw co-rotating extruder with an L/D=10.6 at 190-230° C. Residence time was established at 30 seconds. The extrudate was water cooled and pelletized using a Conair Model 304. The material was dried in a forced air oven at 75° C. for 4 hours prior to molding.

The obtained pellets of compounded mixtures were dried in a circulating air oven ex Heraeus instruments at 120° C. for 4 hours.

### 3. Injection Molding.

Test specimens were prepared by injection molding the pellets of compounded mixtures in Allrounder 500-150 ex. Arburg at 225-240° C.

### 4. Conditioning

Specimens were conditioned at 23° C. for 168 hours before testing.

### 5. Testing

Limiting Oxygen Index (LOI) flammability test was performed on 3.2×125 mm bars according to ASTM D 2863 using Stanton Redcroft FTA Flammability Apparatus

Cone calorimeter tests were performed on Stanton Redcroft Cone calorimeter at 50 kW/m², according to the ASTM E 1354 test method using molded discs of 62 mm diameter and 3.2 mm thickness.

Notched Izod impact strength was measured according to ASTM D 256 using Pendulum type Monitor Impact Tester, TMI—Model 43-02-01

Heat Deflection Temperature (HDT) was measured according to ASTM D 648 using Automatic Deflection Tester Tinius Olsen Model DS-5.

### 6. Results

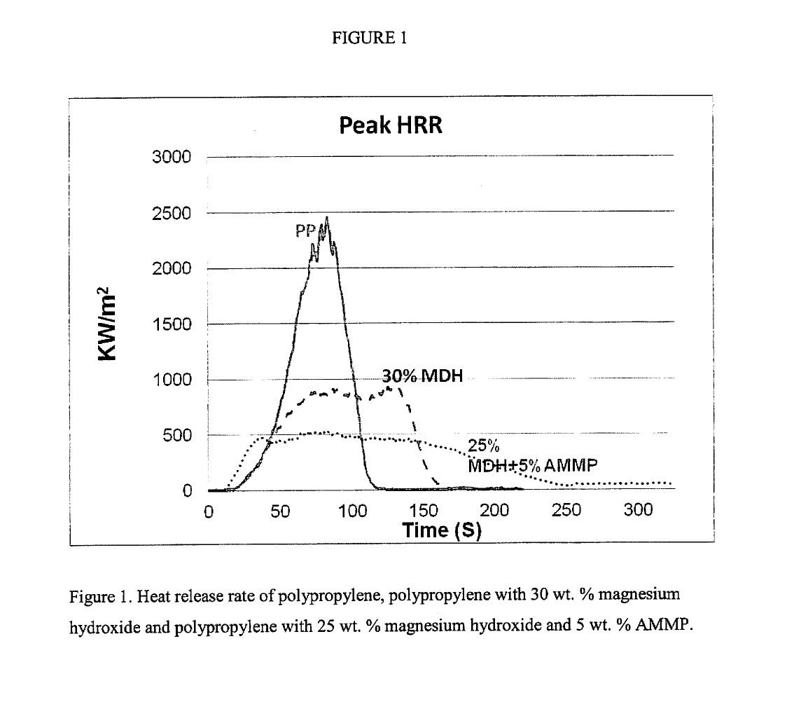

The results of the flammability tests and physical properties are shown in Table 1. The graph of the Heat Release Rate as measured in the Cone calorimeter is shown in FIG. 1.

TABLE 1

| | Comp. Ex. 1 | Comp. Ex. 2 | Ex. 43 |
|---|---|---|---|
| Composition | | | |
| a | 100 | 70 | 70 |
| b | | 30 | 25 |
| c | | | 5 |
| LOI | 17.7 | 19.4 | 19.6 |
| Cone calorimeter | | | |
| data | | | |
| Ignition, sec | 19 | 21 | 12 |
| Total heat, MJ/m² | 105 | 91 | 84 |
| ^{a}HRR, kW/m² | 805 | 550 | 355 |
| Peak HRR, kW/m² | 2540 | 1010 | 545 |
| Physical properties | | | |
| Izod impact, J/m | 635 | 375 | 295 |
| HDT, ° C. (66 psi) | 76 | 86 | 92 |

^{a}HRR—heat release rate

As it is seen in comparative example 2 addition of 30 wt. % of magnesium hydroxide results in increasing of LOI from 17.7 to 19.4 and decreasing of the peak of heat release rate by 1.5 times from 2540 to 1010 kW/m². Total heat evolved also drops at the same time. Further replacement of 5 wt. % MDH with 5 wt. % AMMP (example 3) results in small increase of LOI but very significant drop in peak of heat release rate from 1010 to 550 kW/m². Even taking into consideration that the amount of PP copolymer doesn't change the total heat also decreases. These are indications of the synergistic effect between MDH and AMMP.

1. A flame retarded polyolefin composition comprising a thermoplastic polyolefin polymer, an inorganic flame retardant and a synergist comprising a metal phosphonate represented by the general formula (I): 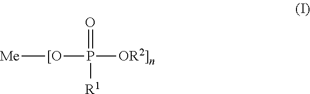
where Me is a metal, n is equal to the valency of the metal and is in the range of from 1 to 4, R¹ is a linear or branched alkyl of up to about 12 carbon atoms, R² is a linear or branched alkyl of up to about 12 carbon atoms, or a substituted aryl or an unsubstituted aryl of the general formula (II): 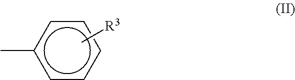
where R³ is hydrogen, or a branched or linear alkyl of up to about 4 carbon atoms, or NH₂ or CN or NO₂, wherein the inorganic flame retardant is present in an amount of from about 5 weight percent to about 40 weight percent.

2. The flame retarded polyolefin composition of claim 1 wherein the thermoplastic polyolefin polymer is at least one of a polyethylene homopolymer, polyethylene copolymer, polypropylene homopolymer and polypropylene copolymer.

3. The flame retarded polyolefin composition of claim 1 wherein the thermoplastic polyolefin polymer is at least one low-density polyethylene (LDPE), linear low-density polyethylene (LLDPE), linear very low-density polyethylene (VLDPE), high-density polyethylene (HDPE), ethylene-methyl methacrylate (EMMA) copolymer, ethylene methyl acrylate (EMA) copolymer, ethylene ethyl acrylate (EEA) copolymer, ethylene butyl acrylate (EBA) copolymer, ethylene vinyl acetate (EVA) copolymer, ethylene glycidyl methacrylate copolymer, ethylene-butene-1 copolymer, ethylene-butene-hexene terpolymer, ethylene propylene diene terpolymer (EPDM), ethylene-octene copolymer (EOR), ethylene copolymerized polypropylene (random PP or block PP), ethylene propylene (EPR) copolymer, poly-4-methyl-pentene-1, maleic anhydride grafted low-density polyethylene, hydrogenated styrene-butadiene (H-SBR) copolymer, maleic anhydride grafted linear low-density polyethylene, maleic anhydride grafted linear very low-density polyethylene, copolymers of ethylene and α-olefin with a carbon number of 4 to 20, ethylene-styrene copolymer, maleic anhydride grafted ethylene-styrene copolymer, maleic anhydride grafted ethylene-methyl acrylate copolymer, maleic anhydride grafted ethylene-vinyl acetate copolymer, ethylene-maleic anhydride copolymer, ethylene-ethyl acrylate-maleic anhydride terpolymer, and ethylene-propylene-butene-1 terpolymer including butene-1, and mixtures thereof.

4. The flame retarded polyolefin composition of claim 1 wherein the inorganic flame retardant is a metal hydroxide selected from the group consisting of aluminum hydroxide, magnesium hydroxide, magnesium basic carbonate, hydrotalcite, calcium aluminate hydrate and combinations thereof.

5. The flame retarded polyolefin composition of claim 1 wherein Me is selected from the group consisting of Ca, Mg, Zn, Al, Fe, Ni, Cr, and Ti.

6. The flame retarded polyolefin composition of claim 1 wherein the metal phosphonate is aluminum methyl methylphosphonate.

7. The flame retarded polyolefin composition of claim 1 wherein an inorganic flame retardant is present in an amount of from about 10 weight percent to about 25 weight percent based on the total weight of the flame retarded polyolefin composition.

8. The flame retarded polyolefin composition of claim 1 wherein an inorganic flame retardant is present in an amount of from about 5 weight percent to less than 20 weight percent based on the total weight of the flame retarded polyolefin composition.

9. The flame retarded polyolefin composition of claim 1 wherein the metal phosphonate is present in an amount of from about 0.5 weight percent to about 25 weight percent of the total weight of the flame retarded polyolefin composition.

10. The flame retarded polyolefin composition of claim 1 wherein the metal phosphonate is present in an amount from about 0.5 weight percent to about 10 weight percent of the total weight of the flame retarded polyolefin composition.

11. The flame retarded polyolefin composition of claim 1 wherein the metal phosphonate is present in an amount from about 0.5 weight percent to about 5 weight percent of the total weight of the flame retarded polyolefin composition.

12. The flame retarded polyolefin composition of claim 1 wherein the metal phosphonate is present in an amount from about 0.5 weight percent to less than 3 weight percent of the total weight of the flame retarded polyolefin composition.

13. A master batch comprising an inorganic flame retardant, a metal phosphonate and a polyolefin polymer carrier comprising a thermoplastic polyolefin polymer.

14. A flame retarded shipping pallet comprising the flame retarded polyolefin composition of claim 1.

15. A method of making a flame retarded polyolefin composition comprising:
contacting at least one thermoplastic polyolefin polymer with at least one inorganic flame retardant and at least one metal phosphonate; and,
heating the mixture of thermoplastic polyolefin polymer, at least one inorganic flame retardant and at least one metal phosphonate to above the melting temperature of the thermoplastic polyolefin polymer, wherein the inorganic flame retardant is present in an amount of from about 5 weight percent to about 40 weight percent.
